(19) United States
(12) Patent Application Publication
(10) Pub. No.: US 2026/0171479 A1
(43) Pub. Date: Jun. 18, 2026

(54) THIN FILM FOR SOLID-STATE BATTERY

(71) Applicant: TOYOTA JIDOSHA KABUSHIKI KAISHA, Toyota-shi (JP)

(72) Inventors: Norihiro OSE, Nagoya-shi (JP); Kenichi KAKISHITA, Nagoya-shi (JP); Yuji YAMASHITA, Toyota-shi (JP)

(73) Assignee: TOYOTA JIDOSHA KABUSHIKI KAISHA, Toyota-shi (JP)

(21) Appl. No.: 19/396,586

(22) Filed: Nov. 21, 2025

(30) Foreign Application Priority Data
Dec. 16, 2024 (JP) 2024-220302

(51) Int. Cl. H01M 10/056

(52) U.S. Cl. CPC H01M 10/056; H01M 2300/0091

(57) ABSTRACT

An object of the present disclosure is to provide a thin film for a solid-state battery that is, due to low residual solvent content, less likely to adversely affect the performance of a solid-state battery and can be manufactured by a roll-to-roll continuous coating method. The present disclosure provides a thin film for a solid-state battery 100 including solid electrolyte particles 110 and crystalline fluororesin 120 and 130 binding the solid electrolyte particles 110 together, in which at least part 130 of the crystalline fluororesin has a fibrous shape, and the content of volatile components measured by a gas analysis means is 10 ppm by mass or less.

### FIELD

The present disclosure relates to a thin film for a solid-state battery.

### BACKGROUND

A solid-state battery is a secondary battery including a solid electrolyte as an electrolyte and is receiving attention due to higher performance with respect to charging performance and the like compared with a liquid electrolyte battery using only a liquid electrolyte as an electrolyte. As a film deposition method for a positive electrode active material layer, a solid electrolyte layer, or a negative electrode active material layer that are included in such a solid-state battery (each of the three types of layers is hereinafter referred to as a thin film for a solid-state battery), a film deposition method of forming a slurry by causing each component to contain a solvent and then coating and drying the slurry (a slurry film deposition method) is generally known.

However, the slurry film deposition method includes a drying process and therefore requires heavy energy consumption and a high equipment cost. On the other hand, a film deposition method not requiring a solvent (a dry film deposition method) has been proposed.

For example, PTL 1 discloses a positive electrode for a secondary battery including a positive electrode active material layer containing at least a positive electrode active material and a solid electrolyte, in which the amount of absorbed oil specified as the amount of linseed oil absorbed within and between primary particles of positive electrode active material particles is 35 to 50 ml per 100 g, the average particle size of a solid electrolyte particle is 1.5 to 2.5 μm, and the positive electrode active material layer is formed by mixing the positive electrode active material particles with the solid electrolyte particles in the absence of a solvent and press molding the mixture. PTL 1 states that the disclosure in PTL 1 can provide a positive electrode for a secondary battery with a high capacity retention rate, a method for manufacturing the positive electrode for a secondary battery, and an all-solid-state secondary battery including the positive electrode.

### CITATION LIST

### Patent Literature

[PTL 1] Japanese Unexamined Patent Publication (Kokai) No. 2014-143133

### SUMMARY

### Technical Problem

The present inventors have found that the presence of a large amount of residual solvent in a thin film for a solid-state battery may degrade the performance of a solid-state battery. On the other hand, formation of a thin film for a solid-state battery by the dry film deposition method as described in PTL 1 can reduce the amount of residual solvent in the thin film for a solid-state battery.

However, a thin film for a solid-state battery needs to be manufactured by a roll-to-roll continuous coating method similarly to conventional methods in order to perform film deposition for a battery in an efficient manufacturing process at a low cost; and there is an issue that flexibility of a thin film for a solid-state battery is low in dry deposition based on a batch-type pressure molding method as described in PTL 1, and the roll-to-roll continuous coating method is not viable.

An object of the present disclosure is to provide a thin film for a solid-state battery that is, due to low residual solvent content, less likely to adversely affect the performance of a solid-state battery and can be manufactured by the roll-to-roll continuous coating method.

### Solution to Problem

The present disclosure achieves the aforementioned objective by the following means.

### Aspect 1

A thin film for a solid-state battery including one or more solid electrolyte particles and crystalline fluororesin binding the solid electrolyte particles together, in which at least part of the crystalline fluororesin has a fibrous shape, and content of a volatile component measured by a gas analysis means is 10 ppm by mass or less.

### Aspect 2

The thin film for a solid-state battery according to Aspect 1, in which content of the volatile component is 1 ppm by mass or less.

### Aspect 3

The thin film for a solid-state battery according to Aspect 1 or 2, in which a particle diameter of the solid electrolyte particle is 1.0 μm or less.

### Aspect 4

The thin film for a solid-state battery according to any one of Aspects 1 to 3, in which content of the crystalline fluororesin is 1.0% by mass or less.

### Aspect 5

The thin film for a solid-state battery according to any one of Aspects 1 to 4, in which content of the crystalline fluororesin is 0.6% by mass or greater.

### Aspect 6

The thin film for a solid-state battery according to any one of Aspects 1 to 5, in which the solid electrolyte particle is a sulfide solid electrolyte particle.

### Aspect 7

The thin film for a solid-state battery according to any one of Aspects 1 to 6, in which the crystalline fluororesin is polytetrafluoroethylene, a perfluoroalkyl compound, a polyfluoroalkyl compound, or a combination of the above.

### Aspect 8

The thin film for a solid-state battery according to any one of Aspects 1 to 7, in which the thin film is a positive electrode active material layer further containing a positive electrode active material.

### Aspect 9

The thin film for a solid-state battery according to any one of Aspects 1 to 7, in which the thin film is a solid electrolyte layer.

### Aspect 10

The thin film for a solid-state battery according to any one of Aspects 1 to 7, in which the thin film is a negative electrode active material layer further containing a negative electrode active material.

### Aspect 11

A solid-state battery including a positive electrode active material layer, a solid electrolyte layer, and a negative electrode active material layer in this order, in which at least one layer selected from the positive electrode active material layer, the solid electrolyte layer, and the negative electrode active material layer is the thin film for a solid-state battery according to any one of Aspects 1 to 7.

### Advantageous Effects of Invention

The present disclosure can provide a thin film for a solid-state battery that is, due to low residual solvent content, less likely to adversely affect the performance of a solid-state battery and can be manufactured by a roll-to-roll continuous coating method.

### BRIEF DESCRIPTION OF DRAWINGS

FIG. 1 is a schematic cross-sectional view for illustrating a thin film for a solid-state battery according to the present disclosure; and

FIG. 2 is a schematic cross-sectional view for illustrating a solid-state battery according to the present disclosure.

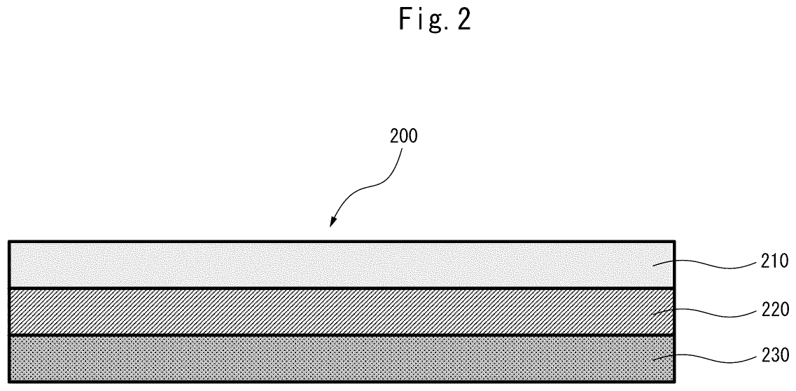

### DESCRIPTION OF EMBODIMENTS

### <<Thin Film for Solid-State Battery>>

A thin film for a solid-state battery according to the present disclosure
includes solid electrolyte particles and crystalline fluororesin binding the solid electrolyte particles together, in which
at least part of the crystalline fluororesin has a fibrous shape, and
the content of volatile components measured by a gas analysis means is 10 ppm by mass or less.

The present disclosure can provide a thin film for a solid-state battery that is, due to low residual solvent content, less likely to adversely affect the performance of a solid-state battery and can be manufactured by a roll-to-roll continuous coating method.

The performance of a solid-state battery may be degraded due to the presence of a large amount of residual solvent, i.e., volatile components in a thin film for a solid-state battery. While not limited to theory, the reason is considered that part of particles included in the thin film for a solid-state battery, such as solid electrolyte particles, are coated by a decomposition product of the volatile components.

On the other hand, the present inventors have found that when the content of volatile components in a thin film for a solid-state battery is 10 ppm by mass or less, the performance degradation of a solid-state battery can be suppressed and preferable physical properties as a solid-state battery can be acquired.

Further, inclusion of crystalline fluororesin as a binder in a thin film for a solid-state battery enables high flexibility after film deposition. While not limited to theory, the reason for improved flexibility is considered that applying shear force to the aforementioned crystalline fluororesin can fiberize the crystalline fluororesin and promote binding between solid electrolyte particles.

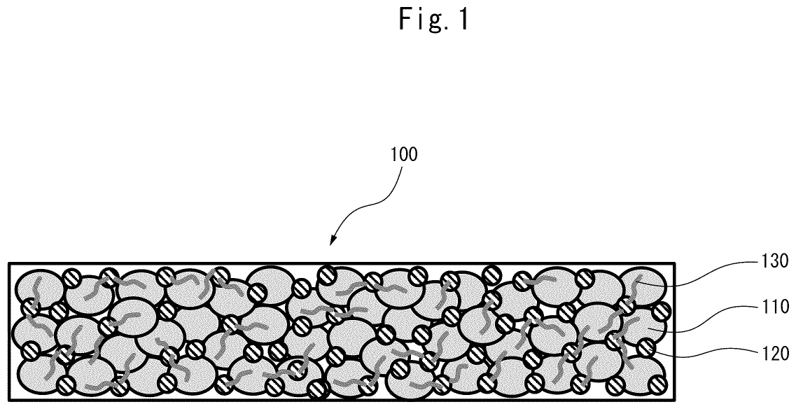

Specifically, for example, as illustrated in FIG. 1, a thin film for a solid-state battery 100 according to the present disclosure includes solid electrolyte particles 110, crystalline fluororesin particles 120, and crystalline fluororesin fibers 130 formed by the fiberization of part of the crystalline fluororesin particles 120. Then, the solid electrolyte particles 110 are bound together by the crystalline fluororesin particles 120 and are also bound together by the crystalline fluororesin fibers 130. Accordingly, the thin film for a solid-state battery 100 has high flexibility.

Each component of the present invention will be described below.

A “thin film for a solid-state battery” herein refers to a positive electrode material layer, a solid electrolyte layer, or a negative electrode active material layer included in a solid-state battery. The thin film for a solid-state battery according to the present disclosure may be applied to one type out of the layers or two or more types.

A “solid-state battery” herein refers to a battery using at least solid electrolyte particles as an electrolyte, and therefore, a solid-state battery may also use a combination of solid electrolyte particles and a liquid electrolyte as the electrolyte. Further, a “solid-state battery” herein may refer to an all-solid-state battery being a battery using only solid electrolyte particles as an electrolyte.

The thin film for a solid-state battery includes solid electrolyte particles and crystalline fluororesin that binds the solid electrolyte particles together. The crystalline fluororesin functions as a binder, and a thin film for a solid-state battery can have high flexibility by the solid electrolyte particles being bound together through the crystalline fluororesin.

The content of the crystalline fluororesin is not particularly limited but may be 1.0% by mass or less, 0.9% by mass or less, or 0.8% by mass or less relative to the thin film for a solid-state battery. Factors adversely affecting the battery performance of a solid-state battery include the presence of additives hindering contact between solid electrolyte particles and reducing the conductivity of lithium ions. Accordingly, inclusion of a large amount of crystalline fluororesin into the thin film for a solid-state battery for enhanced flexibility of the thin film for a solid-state battery reduces the ion conductivity.

The content of the crystalline fluororesin is not particularly limited but is preferably 0.6% by mass or greater, or 0.7% by mass or greater relative to the thin film for a solid-state battery from the viewpoint of ensuring the flexibility of the thin film for a solid-state battery.

The content of the solid electrolyte particles is not particularly limited and may be appropriately determined based on the application, performance, and the like of the thin film for a solid-state battery. For example, the content of the solid electrolyte particles may be 1% by mass or greater, 5% by mass or greater, 10% by mass or greater, 15% by mass or greater, or 20% by mass or greater and may be 90% by mass or less, 80% by mass or less, 70% by mass or less, 60% by mass or less, or 50% by mass or less.

The solid electrolyte particles and particles contained in the thin film for a solid-state battery excluding the solid electrolyte particles may be bound together by the crystalline fluororesin, and the particles contained in the thin film for a solid-state battery excluding the solid electrolyte particles may be bound together by the crystalline fluororesin. Examples of the aforementioned particles contained in the thin film for a solid-state battery excluding the solid electrolyte particles include particles of a positive electrode active material, a negative electrode active material, and a conductive additive.

The content of volatile components in the thin film for a solid-state battery according to the present disclosure measured by a gas analysis means is 10 ppm by mass or less. The amount of the volatile components is preferably minimized from the viewpoint of preventing degradation in the battery performance. The aforementioned content may be 8 ppm by mass or less, 6 ppm by mass or less, 4 ppm by mass or less, 2 ppm by mass or less, or 1 ppm by mass or less. Further, the aforementioned content may be 1 ppb by mass or greater, 10 ppb by mass or greater, or 100 ppb by mass or greater. When a plurality of types of volatile components are present, the aforementioned content refers to the content of each volatile component.

The content of the volatile components was measured by a gas analysis means. The gas analysis means can measure the content by performing qualitative analysis and quantitative analysis on a target solvent by temperature-programmed desorption mass spectrometry (TPD-MS) using a mass spectrometer (GC/MS-QP2010, manufactured by Shimadzu Corporation) with a built-in heating device. Note that helium is used as a carrier gas and is heated to 250° C. at a rate of 10 degrees/minute by the heating device.

A “volatile component” herein refers to a solvent being used in the manufacturing process of a thin film for a solid-state battery and being a component remaining in the thin film for a solid-state battery. Examples of the solvent include alcohols such as methanol, ethanol, propanol, and butanol; aliphatic hydrocarbons such as hexane and heptane; ketones such as acetone, methyl ethyl ketone, and 2-pentanone; and esters such as ethyl acetate and butyl acetate.

The flexibility of the thin film for a solid-state battery is not particularly limited and may be appropriately determined according to the required performance of the solid-state battery, and the like. For example, the flexibility of the thin film for a solid-state battery may be measured as the diameter of a cylinder at which cracks starts to form in the electrode active material layer when a laminate including the thin film is wound around the cylinder in a cylindrical mandrel test; and the diameter may be 45 mm or less, 40 mm or less, 35 mm or less, 30 mm or less, 25 mm or less, or 20 mm or less, and may be 5 mm or greater, 10 mm or greater, or 15 mm or greater.

For example, the shape of the thin film for a solid-state battery is not particularly limited but may be a sheet shape with an almost flat surface. For example, the thickness of the thin film for a solid-state battery is not particularly limited but may be 0.1 μm or greater, 1 μm or greater, or 10 μm or greater, and may be 2 mm or less, 1 mm or less, or 500 μm or less.

The method for depositing a thin film for a solid-state battery is not particularly limited but preferably forms the film by a dry film deposition method not requiring volatile components from the viewpoint of reducing the content of volatile components in the thin film for a solid-state battery.

### <Solid Electrolyte Particle>

The particle diameter of the solid electrolyte particle may be 1.0 μm or less. A smaller particle diameter can enhance the flexibility of the thin film for a solid-state battery. While not limited to theory, the reason is considered that a smaller particle diameter of the solid electrolyte particle allows the solid electrolyte particles to efficiently apply shear force to the crystalline fluororesin when the solid electrolyte particles and the crystalline fluororesin are kneaded together, resulting in an increased amount of fiberized crystalline fluororesin. The particle diameter of the solid electrolyte particle may be 0.9 μm or less, 0.8 μm or less, 0.7 μm or less, or 0.5 μm or less and may be 0.1 μm or greater, 0.2 μm or greater, or 0.3 μm or greater.

The particle diameter of the solid electrolyte particle is a particle diameter (a median diameter) at a cumulative value of 50% in the volume-based particle size distribution found by a laser diffraction and scattering method.

The solid electrolyte particles are not limited but may be sulfide solid electrolyte particles. Further, examples of the solid electrolyte particles may include oxide solid electrolyte particles and polymer electrolyte particles.

Examples of the sulfide solid electrolyte particles may include sulfide-based amorphous solid electrolyte particles, sulfide-based crystalline solid electrolyte particles, and argyrodite-type solid electrolyte particles but are not limited thereto. Specific examples of the sulfide solid electrolyte particles include Li₂S—P₂S₅-based particles (e.g., Li₇P₃S₁₁, Li₃PS₄, and Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (e.g., Li₁₃GeP₃S₁₆ and Li₁₀GeP₂S₁₂), LiI—Li₂S—P₂O₅, LiI—Li₃PO₄—P₂S₅, Li₇₋ₓPS₆₋ₓClₓ, and combinations thereof but are not limited thereto.

Examples of the oxide solid electrolyte particles may include Li₇La₃Zr₂O₁₂, Li₇₋ₓ La₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ(LiPON), and combinations thereof but are not limited thereto.

The sulfide solid electrolyte particles and the oxide solid electrolyte particles may be based on glass or crystalline glass (glass ceramics).

Examples of the polymer electrolyte particles include polyethylene oxide (PEO), polypropylene oxide (PPO), and copolymers thereof but are not limited thereto.

### <Crystalline Fluororesin>

At least part of the crystalline fluororesin has a fibrous shape. The fibrous shape of the crystalline fluororesin enhances the binding property between solid electrolyte particles and enables high flexibility.

Examples of the crystalline fluororesin may include polytetrafluoroethylene (PTFE), perfluoroalkyl compounds, and polyfluoroalkyl compounds but are not particularly limited thereto. One type of material of the crystalline fluororesin may be used alone, or two or more types may be used in combination.

Examples of the perfluoroalkyl compounds may include perfluorooctanesulfonic acid (PFOS), perfluorooctanoic acid (PFOA), and perfluorohexanesulfonic acid (PFHxS).

Examples of the polyfluoroalkyl compounds may include polyfluoroalkyl vinyl ether (PFA) and polyfluoroalkyl acrylate (PFAA).

The crystalline fluororesin may include resin with a particulate shape. The particle diameter of the crystalline fluororesin may be 0.5 μm or less, 0.4 μm or less, 0.3 μm or less, 0.2 μm or less, or 0.1 μm or less, and may be 0.01 μm or greater, 0.03 μm or greater, or 0.05 μm or greater but is not particularly limited thereto. The particle diameter of the crystalline fluororesin is a particle diameter (a median diameter) at a cumulative value of 50% in the volume-based particle size distribution found by the laser diffraction and scattering method.

Examples of the method for manufacturing the fibrous crystalline fluororesin are not particularly limited but may include fiberizing part of particulate crystalline fluororesin by kneading the crystalline fluororesin with solid electrolyte particles while applying shear force.

### <Positive Electrode Active Material Layer>

The thin film for solid-state batteries may be a positive electrode active material layer further containing a positive electrode active material. In this case, the positive electrode active material layer contains at least a positive electrode active material, solid electrolyte particles, and crystalline fluororesin and may optionally contain a conductive additive. As for the solid electrolyte particles, reference may be made to the aforementioned description of the solid electrolyte particles; and as for the crystalline fluororesin, reference may be made to the aforementioned description of the crystalline fluororesin. In addition, the positive electrode active material layer may also contain various additives.

The content of each of the positive electrode active material, the solid electrolyte particles, and the conductive additive in the positive electrode active material layer may be appropriately determined according to the target battery performance. For example, assuming the entire positive electrode active material layer (the total solid content) to be 100% by mass, the content of the positive electrode active material may be 40% by mass or greater, 50% by mass or greater, or 60% by mass or greater, and may be 100% by mass or less, or 90% by mass or less.

### (Positive Electrode Active Material)

The material for the positive electrode active material is not particularly limited as long as the material can occlude and release lithium ions. Examples of the positive electrode active material may include lithium cobalt oxide (LiCoO₂), lithium nickel oxide (LiNiO₂), lithium manganese oxide (LiMn₂O₄), lithium nickel manganese cobalt oxide (NCM: LiCo_{1/3}Ni_{1/3}Mn_{1/3}O₂), lithium nickel cobalt aluminum oxide [LiNi_{0.8}(CoAl)_{0.2}O₂], and hetero-element-substituted Li—Mn spinels the composition of which is represented by Li₁₊ₓMn_{2-x-y}M_{y}O₄ (where M is one or more metallic elements selected from Al, Mg, Co, Fe, Ni, and Zn) but are not limited thereto.

The positive electrode active material is not particularly limited but may include a covering layer. The covering layer is a layer that contains a material having lithium ion conductivity, having low reactivity with the positive electrode active material and the solid electrolyte particles, and being able to maintain a form that does not flow even when the covering layer comes in contact with the active material or the solid electrolyte particles. Specific examples of the material constituting the covering layer may include Li₄Ti₅O₁₂ and Li₃PO₄ in addition to LiNbO₃ but are not limited thereto.

The shape of the positive electrode active material is not specifically limited as long as the shape is a shape generally used as a positive electrode active material in a battery. For example, the positive electrode active material may have a particulate shape. The positive electrode active material may be constituted of primary particles or secondary particles formed by aggregation of a plurality of primary particles. For example, the particle diameter of the positive electrode active material may be 1 nm or greater, 5 nm or greater, or 10 nm or greater, and may be 500 μm or less, 100 μm or less, 50 μm or less, or 30 μm or less. Note that the particle diameter of the positive electrode active material is a particle diameter (a median diameter) at a cumulative value of 50% in the volume-based particle size distribution found by the laser diffraction and scattering method.

### (Conductive Additive)

The conductive additive is not particularly limited. Examples of the conductive additive may include vapor-grown carbon fibers (VGCF), acetylene black (AB), ketjen black (KB), carbon nanotubes (CNT), and carbon nanofibers (CNF) but are not limited thereto. For example, the conductive additive may have a particulate shape or a fibrous shape, the size of which is not particularly limited. The conductive additive is not particularly limited, but one type may be used alone, or two or more types may be used in combination.

### <Solid Electrolyte Layer>

The thin film for a solid-state battery may be a solid electrolyte layer. In this case, the solid electrolyte layer contains at least solid electrolyte particles and crystalline fluororesin and may optionally contain a conductive additive. As for the solid electrolyte particles, reference may be made to the aforementioned description of the solid electrolyte particles; and as for the conductive additive, reference may be made to the aforementioned description of the conductive additive. In addition, the solid electrolyte layer may also contain various additives.

### <Negative Electrode Active Material Layer>

The thin film for a solid-state battery may be a negative electrode active material layer further containing a negative electrode active material. In this case, the negative electrode active material layer contains at least a negative electrode active material, solid electrolyte particles, and crystalline fluororesin and may optionally contain a conductive additive. As for the solid electrolyte particles, reference may be made to the aforementioned description of the solid electrolyte particles; as for the crystalline fluororesin, reference may be made to the aforementioned description of the crystalline fluororesin; and as for the conductive additive, reference may be made to the aforementioned description of the conductive additive. In addition, the negative electrode active material layer may also contain various additives.

The content of each of the negative electrode active material, the solid electrolyte particles, and the conductive additive in the negative electrode active material layer may be appropriately determined according to the target battery performance. For example, assuming the entire negative electrode active material layer (the total solid content) to be 100% by mass, the content of the negative electrode active material may be 40% by mass or greater, 50% by mass or greater, or 60% by mass or greater and may be 100% by mass or less or 90% by mass or less.

### (Negative Electrode Active Material)

Various materials having a potential at which lithium ions are occluded and released (a charging and discharging potential) lower than that of the positive electrode active material according to the present disclosure may be employed as the negative electrode active material. The material for the negative electrode active material may be metallic lithium or a material that can occlude and release metallic ions, such as lithium ions, but is not particularly limited thereto. Examples of the material that can occlude and release metallic ions, such as lithium ions, may include alloy-based negative electrode active materials, carbon materials, and lithium titanate (Li₄Ti₅O₁₂) but are not limited thereto.

Examples of the alloy-based negative electrode active material include Si-alloy-based negative electrode active materials and Sn-alloy-based negative electrode active materials but are not particularly limited thereto. Examples of the Si-alloy-based negative electrode active material include silicon, silicon oxides, silicon carbides, silicon nitrides, and solid solutions thereof. Further, the Si-alloy-based negative electrode active materials may contain metallic elements other than silicon, such as Fe, Co, Sb, Bi, Pb, Ni, Cu, Zn, Ge, In, Sn, and Ti. Examples of the Sn-alloy-based negative electrode active material include tin, tin oxides, tin nitrides, and solid solutions thereof. Further, the Sn-alloy-based negative electrode active materials may contain metallic elements other than tin, such as Fe, Co, Sb, Bi, Pb, Ni, Cu, Zn, Ge, In, Ti, and Si.

Examples of the carbon materials include hard carbon, soft carbon, and graphite but are not particularly limited thereto.

The shape of the negative electrode active material is not particularly limited and has only to be a shape generally used as a negative electrode active material in a battery. For example, the negative electrode active material may have a particulate shape or a sheet shape.

### <<Solid-State Battery>>

A solid-state battery according to the present disclosure includes
a positive electrode active material layer, a solid electrolyte layer, and a negative electrode active material layer in this order, in which
at least one layer selected from the aforementioned positive electrode active material layer, the aforementioned solid electrolyte layer, and the aforementioned negative electrode active material layer is the thin film for a solid-state battery according to the present disclosure.

The present disclosure can provide a solid-state battery including a thin film for a solid-state battery that is, due to low residual solvent content, less likely to adversely affect the performance of a solid-state battery and can be manufactured by a roll-to-roll continuous coating method.

The solid-state battery according to the present disclosure includes at least a positive electrode active material layer, a solid electrolyte layer, and a negative electrode active material layer in this order and may optionally include a positive electrode collector layer, a negative electrode collector layer, and a liquid electrolyte.

Specifically, for example, a solid-state battery 200 includes a positive electrode active material layer 210, a solid electrolyte layer 220, and a negative electrode active material layer 230 in this order, as illustrated in FIG. 1.

At least one layer selected from the positive electrode active material layer, the solid electrolyte layer, and the negative electrode active material layer is the thin film for a solid-state battery according to the present disclosure. Two or more of the layers may be the thin film for a solid-state battery according to the present disclosure. As for the positive electrode active material layer, reference may be made to the aforementioned description of the positive electrode active material layer; as for the solid electrolyte layer, reference may be made to the aforementioned description of the solid electrolyte layer; and as for the negative electrode active material layer, reference may be made to the aforementioned description of the negative electrode active material layer.

### <Positive Electrode Collector Layer>

The material used for the positive electrode collector layer is not particularly limited, and a material generally used as a positive electrode collector in a solid-state battery may be appropriately employed. Examples of the materials used for the positive electrode collector layer may include Cu, Ni, Cr, Au, Pt, Ag, Al, Fe, Ti, Zn, Co, and stainless steel but are not limited thereto. Further, the positive electrode collector layer may have some coating layer on the surface thereof for the purpose of resistance adjustment and the like. Further, the positive electrode collector layer may be acquired by plating a metallic foil or a substrate with the aforementioned metal or depositing the metal on the metallic foil or the substrate.

Examples of the shape of the positive electrode collector layer are not particularly limited but may include a foil shape, a plate shape, and a mesh shape. A foil shape is preferable among the shapes. The thickness of the positive electrode collector layer is not particularly limited, but may be 0.1 μm or greater, or 1 μm or greater, and may be 1 mm or less, or 100 μm or less.

### <Negative Electrode Collector Layer>

The material used for the negative electrode collector layer is not particularly limited, and a material generally used as a negative electrode collector in a solid-state battery may be appropriately employed. Examples of the material used for the negative electrode collector layer may include Cu, Ni, Cr, Au, Pt, Ag, Al, Fe, Ti, Zn, Co, stainless steel, and a carbon sheet but are not limited thereto. The negative electrode collector layer may have some coating layer on the surface thereof for the purpose of resistance adjustment and the like.

Examples of the shape of the negative electrode collector layer are not particularly limited but may include a foil shape, a plate shape, and a mesh shape. A foil shape is preferable among the shapes. The thickness of the negative electrode collector layer is not particularly limited, but may be 0.1 μm or greater, or 1 μm or greater, and may be 1 mm or less, or 100 μm or less.

### <Liquid Electrolyte>

The liquid electrolyte is not particularly limited but preferably contains a supporting salt and a solvent.

Examples of the supporting salt (lithium salt) in a lithium-ion-conductive electrolyte solution are not particularly limited but may include inorganic lithium salts and organic lithium salts. Examples of the inorganic lithium salt may include LiPF₆, LiBF₄, LiClO₄, and LiAsF₆ but are not limited thereto. Examples of the organic lithium salt include LiCF₃SO₃, LiN(CF₃SO₂)₂, LiN(C₂F₅SO₂)₂, LiN(FSO₂)₂, and LiC(CF₃SO₂)₃ but are not limited thereto.

Examples of the solvent used in the electrolyte solution are not particularly limited but may include cyclic carbonates and chain carbonates. Examples of the cyclic carbonate may include ethylene carbonate (EC), propylene carbonate (PC), and butylene carbonate (BC) but are not limited thereto. Examples of the chain carbonate may include dimethyl carbonate (DMC), diethyl carbonate (DEC), and ethyl methyl carbonate (EMC) but are not limited thereto. The electrolyte solution is not particularly limited, but one type may be used alone, or two or more types may be used in combination.

### EXAMPLES

While the present disclosure will be specifically described by using Examples and Comparative Examples, the present disclosure is not limited thereto.

### <<Production of Thin Film for Solid-State Battery>>

### Examples 1 to 4

As presented in Table 1, Li₂S—P₂S₅-based solid electrolyte particles were kneaded with PTFE being crystalline fluororesin as a binder while applying shear force. The acquired mixture was press-molded into a plate shape by a dry film deposition method and was used as a thin film for a solid-state battery in Examples 1 to 4.

### Comparative Example 1

As presented in Table 1, Li₂S—P₂S₅-based particles as solid electrolyte particles and PVDF as a binder were mixed in the presence of a solvent to acquire a slurry. The aforementioned slurry was coated by a blade method using an applicator and dried to form a thin film for a solid-state battery in Comparative Example 1.

### <Measurement of Volatile Component Content>

The amount of volatile components contained in the thin film for a solid-state battery in each of Examples 1 to 4 and Comparative Example 1 was measured by performing qualitative analysis and quantitative analysis on a target solvent by temperature-programmed desorption mass spectrometry (TPD-MS) using a mass spectrometer (GC/MS-QP2010, manufactured by Shimadzu Corporation) with a built-in heating device. Note that helium was used as a carrier gas and was heated to 250° C. at a rate of 10 degrees/minute by the heating device. The measurement results are presented in Table 1.

### <<Evaluation>>

### <Presence of Degradation of Solid Electrolyte Particles>

The presence of degradation of solid electrolyte particles was confirmed by an ion electroconductivity measurement and an elemental analysis. The evaluation criterion was as follows.
A: Degradation of the solid electrolyte particles is not confirmed by the ion electroconductivity measurement and the elemental analysis.
B: Degradation of the solid electrolyte particles is confirmed by the ion electroconductivity measurement and the elemental analysis.

### <Flexibility of Thin Film for Solid-State Battery>

The flexibility of the thin film for a solid-state battery in each of Examples 1 to 4 and Comparative Example 1 was evaluated by a cylindrical mandrel test by winding a laminate including the thin film around cylinders with diameters of 40 mm and 50 mm. The evaluation criterion was as follows.
A: When wound around the cylinder with a diameter of 40 mm, the thin film for a solid-state battery does not incur damage and exhibits sufficient flexibility.
B: When wound around the cylinder with a diameter of 50 mm, the thin film for a solid-state battery does not incur damage and exhibits sufficient flexibility.
C: When wound around the cylinder with a diameter of 50 mm, the thin film for a solid-state battery incurs damage and does not exhibit sufficient flexibility.

The evaluation results are presented in Table 1.

TABLE 1

| | | | | | | | Comparative |
|---|---|---|---|---|---|---|---|
| | | | Example 1 | Example 2 | Example 3 | Example 4 | Example 1 |
| Thin film | Solid | Particle | 5 | 1 | 1 | 1 | 5 |
| for solid- | electrolyte | diameter | | | | | |
| state | particles | (μm) | | | | | |
| battery | Binder | Type | PTFE | PTFE | PTFE | PTFE | PVDF |
| | | Content | 3 | 3 | 0.5 | 1 | 3 |
| | | relative to | | | | | |
| | | solid | | | | | |
| | | electrolyte | | | | | |
| | | layer (% | | | | | |
| | | by mass) | | | | | |

| | | | | | | |
|---|---|---|---|---|---|---|
| | Film deposition method | Dry film | Dry film | Dry film | Dry film | Slurry |
| | | deposition | deposition | deposition | deposition | coating |
| | Volatile component | less than 1 | less than 1 | less than 1 | less than 1 | 800 |
| | content (ppm by mass) | | | | | |
| Evaluation | Presence of degradation | A | A | A | A | B |
| | of solid electrolyte | | | | | |
| | Flexibility of thin film | B | A | B | A | A |
| | for solid-state battery | | | | | |

From Examples 1 to 4 and Comparative Example 1 in Table 1, it can be understood that when the amount of volatile components contained in the thin film for a solid-state battery is small, no degradation of the solid electrolyte is confirmed, and the thin film for a solid-state battery does not adversely affect the performance of the solid-state battery.

From Examples 1 and 2 in Table 1, it can be understood that a smaller particle diameter of the solid electrolyte results in an increased amount of fibrous crystalline fluororesin, which leads to higher flexibility of the solid electrolyte layer. Accordingly, it can be understood that a smaller particle diameter of the solid electrolyte is a more preferable condition.

### REFERENCE SIGNS LIST

100 Thin film for solid-state battery
110 Solid electrolyte particle
120 Crystalline fluororesin particle
130 Crystalline fluororesin fiber
200 Solid-state battery
210 Positive electrode active material layer
220 Solid electrolyte layer
230 Negative electrode active material layer

1. A thin film for a solid-state battery comprising one or more solid electrolyte particles and crystalline fluororesin binding the solid electrolyte particles together, wherein
at least part of the crystalline fluororesin has a fibrous shape, and
content of a volatile component measured by gas analysis means is 10 ppm by mass or less.

2. The thin film for a solid-state battery according to claim 1, wherein content of the volatile component is 1 ppm by mass or less.

3. The thin film for a solid-state battery according to claim 1, wherein a particle diameter of the solid electrolyte particle is 1.0 μm or less.

4. The thin film for a solid-state battery according to claim 1, wherein content of the crystalline fluororesin is 1.0% by mass or less.

5. The thin film for a solid-state battery according to claim 1, wherein content of the crystalline fluororesin is 0.6% by mass or greater.

6. The thin film for a solid-state battery according to claim 1, wherein the solid electrolyte particle is a sulfide solid electrolyte particle.

7. The thin film for a solid-state battery according to claim 1, wherein the crystalline fluororesin is polytetrafluoroethylene, a perfluoroalkyl compound, a polyfluoroalkyl compound, or a combination of the above.

8. The thin film for a solid-state battery according to claim 1, wherein the thin film is a positive electrode active material layer further containing a positive electrode active material.

9. The thin film for a solid-state battery according to claim 1, wherein the thin film is a solid electrolyte layer.

10. The thin film for a solid-state battery according to claim 1, wherein the thin film is a negative electrode active material layer further containing a negative electrode active material.

11. A solid-state battery comprising a positive electrode active material layer, a solid electrolyte layer, and a negative electrode active material layer in this order, wherein
at least one layer selected from the positive electrode active material layer, the solid electrolyte layer, and the negative electrode active material layer is the thin film for a solid-state battery according to claim 1.
